(19) United States
(12) Patent Application Publication
(10) Pub. No.: US 2008/0130548 A1
(43) Pub. Date: Jun. 5, 2008

(54) Control signaling for multimedia broadcast multicast service point-to-multipoint over high speed downlink packet access information

(75) Inventors: Jorma Kaikkonen, Oulu (FI); Juho Pirskanen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/982,847

(22) Filed: Nov. 5, 2007

Related U.S. Application Data
(60) Provisional application No. 60/856,497, filed on Nov. 3, 2006.

(51) Int. Cl. H04H 20/71

(52) U.S. Cl. 370/312; 370/432

(57) ABSTRACT

Multimedia broadcast multicast service over point-to-multipoint high speed downlink packet access is provided by modifying the high speed downlink packet access system or service information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.

### CROSS REFERENCE TO RELATED APPLICATIONS

Reference is made to and priority claimed from U.S. provisional application Ser. No. 60/856,497, filed Nov. 3, 2006.

### FIELD OF THE INVENTION

The invention relates to the field of wireless communication systems and cellular radio access and more specifically deals with Multimedia Broadcast Multicast Service in such wireless communications systems. In particular, the invention relates to providing control information for high speed data packet access (HSDPA) point-to-multipoint operation in such wireless communications systems.

### LIST OF ABBREVIATIONS

ACI: Adjacent Channel Interference
ACK: Acknowledgement
AM RLC: Acknowledged Mode Radio Link
ACPR: Adjacent channel power ratio
AP: Access Point
B3G: Beyond 3rd Generation
BCCH: Broadcast Control Channel
CELL_DCH: Dedicated Channel State
CELL_FACH: Forward Access Channel
CELL/URA_PCH: Paging Channel State
CN: Core Network
CHUNK: Basic time-frequency resource unit for OFDM links
CQI: Channel quality information
DCCH: Dedicated Control Channel
DL: Downlink
DRX: Discontinuous Reception
DTCH: Dedicated Traffic Channel
DTX: Discontinuous Transmission
FDD: Frequency division duplex
H-RNTI: High Speed Downlink Shared Channel Radio Network
Transaction Identifier
HARQ: Hybrid Automatic Repeat Request
HSDPA: High Speed Downlink Packet Access
HS-DSCH: High Speed Downlink Shared Channel
HS-PDSCH: High Speed Physical Downlink Shared Channel
HS-SCCH: High Speed Shared Control Channel
LTE: Long Term Evolution
MBMS: Multimedia Broadcast Multicast Service
MCCH: MBMS P-T-M Control Channel
MCS: Modulation and Coding Scheme
MSCH: MBMS P-T-M Scheduling Channel
MTCH: MBMS P-T-M Traffic Channel
MIMO: Multiple Input-Multiple Output
MT: Narrowband (FDD mode of the WINNER system)
NACK: Negative Acknowledgement
NBAP: Node B Application Protocol
OFDM: Orthogonal Frequency Division Multiplexing
P-T-M: Point-To-Multipoint
P-T-P: Point-To-Point
PLMN: Public Land Mobile Network
QAM: Quadrature Amplitude Modulation
QPSK: Quadrature Phase Shift Keying
RAN: Radio Access Network
RAT: Radio Access Technology
RBS: Radio Base Station
RLC PDU: Radio Link Control Protocol Data Unit
RNC: Radio Network Controller
RRC: Radio Resource Control
RRM: Radio Resource Management
RTNI: Radio Network Transaction Identifier
S-CCPCH: Secondary Common Control Physical Channel
SIB: System Information Broadcast
SRB: Signaling Radio Bearers
TCTF: Target Channel Type Field
TDD: Time division duplex
TTI: Transmission Time Interval
UE: User Equipment
UL: Uplink
UMTS: Universal Mobile Telecommunications System
UM RLC: Unacknowledged Mode Radio Link
UT: User Terminal
UTRAN: UMTS Terrestrial Radio Access Network
WB: Wideband (TDD mode of the WINNER system)
WLAN: Wireless Local Area Network
WINNER: Wireless World Initiative New Radio

### BACKGROUND OF THE INVENTION

The requirements for 3GPP Release 6 MBMS are described in the technical report document, 3GPP TR 25.992: “Multimedia Broadcast/Multicast Service (MBMS); UTRAN/GERAN requirements”. The requirements are specified at the physical layer level to: (i) use the Forward Access transport Channel (FACH) mapped to the Secondary Common Control Physical CHannel (S-CCPCH) for point-to-multipoint (P-T-M) transmission, or (ii) use the Dedicated transport Channel (DCH) mapped to the Dedicated Physical Data CHannel (DPDCH).

Additionally the utilization of high speed downlink shared channel (HS-DSCH) has been made possible for MBMS P-T-P transmission mode in cases where the UE supports both MBMS and HSDPA. Issues and considerations related to the selection between P-T-P and P-T-M transmission modes and the utilized P-T-P transport channel is left for UTRAN RRM future implementation, however one essential factor in the consideration of the P-T-P and P-T-M selection is the number of users of the service.

The technical report document, 3GPP TR 25.992: “Multimedia Broadcast/Multicast Service (MBMS); UTRAN/GERAN requirements” does not define the physical channel (HS-DSCH) carrying the MBMS P-T-M logical channels (MCCH and MTCH) for MBMS over P-T-M HSDPA.

Some proposed solutions for providing MBMS over P-T-M HS-DSCH include the use of: a common ID in H-RNTI detection for enhanced CELL_FACH operation, and a broadcast HS-SCCH channelization code for enhanced CELL_FACH operation both of which are described in the patent application titled “User Equipment”, U.S. patent application Ser. No. 11/673,074, filed Feb. 9, 2007, and Great Britain patent application, titled “User Equipment”, serial number 0602762.7, filed Feb. 10, 2006, the disclosures of both which are incorporated herein by reference.

Other proposed solutions for providing MBMS over P-T-M HS-DSCH include receiving the MCCH configuration mapped to the S-CCPCH from the SIB including modification and repetition periods and receiving the MTCH configuration mapped on the S-CCPCH from the MCCH.

The proposed solutions described above for defining the physical channel (HS-DSCH) carrying the MBMS P-T-M logical channels (MCCH and MTCH) for MBMS over P-T-M HSDPA are not satisfactory because they require substantial changes to the logical channel configurations and Uu signaling flows among other disadvantages.

Accordingly, an efficient and straightforward way to define the physical channel (HS-DSCH) carrying the MBMS P-T-M logical channels (MCCH and MTCH) for MBMS over P-T-M HSDPA is needed.

### SUMMARY OF THE INVENTION

In accordance with a broad aspect of the invention, multimedia broadcast multicast service over point-to-multipoint high speed downlink packet access is provided by modifying the high speed downlink packet access system or service information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.

### BRIEF DESCRIPTION OF THE DRAWINGS

FIG. 1 is a schematic functional representation of a Multimedia Broadcast Multicast Service in accordance with some embodiments of the invention showing the MBMS in a broadcast transmission mode of operation.

FIG. 2 is a schematic functional representation of a Multimedia Broadcast Multicast Service in accordance with some embodiments of the invention showing the MBMS in a multicast transmission mode of operation.

FIG. 3 is a schematic functional representation of a Multimedia Broadcast Multicast Service in accordance with some embodiments of the invention showing the MBMS in P-T-M and P-T-P transmission modes of operation.

FIG. 4A shows a flowchart of the basic steps of the method according to some embodiments of the invention for providing MBMS over HSDPA information.

FIG. 4B shows a flowchart of the basic steps of the method according to some embodiments of the invention for providing MBMS over HSDPA information.

FIG. 4C shows a flowchart of the basic steps of the method according to some embodiments of the invention for providing MBMS over HSDPA information.

FIG. 4D shows a flowchart of the basic steps of the method according to some embodiments of the invention for providing MBMS over HSDPA system information.

FIG. 4E shows a flowchart of the basic steps of the method according to some embodiments of the invention for providing MBMS over HSDPA service information.

FIGS. 5A and 5B show an MBMS P-T-M over HSDPA enabled apparatus according to some embodiments of the invention for providing MBMS over HSDPA information.

FIG. 6 is a functional block diagram of an example of a signal processor for carrying out the invention.

FIG. 7 is a functional block diagram of an example of a UE or mobile terminal for carrying out the steps of the method according to some embodiments of the invention.

FIG. 8 is a block diagram/flow diagram of a wireless communication system according to which some embodiments of the present invention may be implemented, including various communication terminals, and in particular a user equipment (UE) terminal and a wireless terminal of a radio access network (RAN).

FIG. 9 is a reduced block diagram (only portions relevant to the invention being shown) of the UE terminal or the wireless terminal of the RAN of FIG. 8.

FIG. 10 is a reduced block diagram of two communications terminals of FIG. 8 in terms of a multi-layered communication protocol stack.

FIG. 11 is a reduced block diagram of the user equipment terminal and the wireless terminal of the radio access network in terms of functional blocks corresponding to hardware equipment used in sending and receiving communication signals over an air interface communication channel linking the two communications terminals.

FIG. 12 shows an example of an E-UTRAN wireless communications system architecture with which the steps of the method according to some embodiments of the invention may be used.

### DESCRIPTION OF EXEMPLARY EMBODIMENTS OF THE INVENTION

In 3GPP Release 6 MBMS, the MBMS was specified at the medium access layer (MAC) level to use the dedicated control logical channel (DCCH) and dedicated traffic logical channel (DTCH) in the P-T-P transmission scenario. In the P-T-M scenario, the MBMS is specified to use the MBMS P-T-M control channel (MCCH), MBMS P-T-M scheduling channel (MSCH) and MBMS P-T-M traffic logical channel (MTCH).

The intention in providing the MBMS over HSDPA is to provide multicast service over HS-DSCH. This can be achieved by creating and using a ‘common’ user equipment identification (UE-id) on the HS-SCCH for providing means for multiple UEs to listen to the HS-PDSCH transmission, i.e. creating a P-T-M connection.

In 3GPP Release 6 MBMS, the MBMS system information is broadcast via the broadcast control channel (BCCH). The ‘Secondary CCPCH information MBMS’ (as part of ‘Secondary CCPCH system information’ specified in the document in System Information Broadcast technical specification SIB5 [TS25.331]) carries the MCCH access information, e.g. provides the detailed information for the UE on S-CCPCH carrying the MCCH e.g. spreading factor and channelization code number, etc. Thus, the MCCH is a cell specific MBMS P-T-M control channel and control information from all MBMS services transmitted on the service specific MTCH is transmitted in the same MCCH.

The MCCH is a logical channel and is always mapped to one specific FACH in the S-CCPCH as indicated on the BCCH. If the MCCH is the only logical channel mapped in to the FACH, the absence of the target channel type field (TCTF) field is explicitly signaled, otherwise the TCTF field is used in the MAC header to identify the MCCH logical channel type.

The MBMS P-T-M traffic channel (MTCH) radio bearer information is carried on the MBMS P-T-M control channel (MCCH). The information includes MBMS Service id, radio bearer, transport channel and physical channel information per MBMS service.

The MTCH is a logical channel and is used for P-T-M downlink transmission of user plane information between the network and UE's in the RRC Connected or Idle Mode. The user plane information on MTCH is MBMS Service specific and is sent to UE's in a cell with an activated MBMS service. The MTCH is always mapped to one specific FACH in the S-CCPCH as indicated on the MCCH. The TCTF field is always used in MAC header to identify MTCH logical channel type

The MSCH is a logical channel and is used for a P-T-M downlink transmission of an MBMS service transmission schedule between the network and UE's in the RRC Connected or Idle Mode. The control plane information on MSCH is MBMS service and S-CCPCH specific and is sent to the UE's in a cell receiving the MTCH. One MSCH is sent in each S-CCPCH carrying the MTCH. The MSCH is always mapped to one specific FACH in the S-CCPCH as indicated on the MCCH. Due to different error requirements, the MSCH is mapped to a different FACH than the MTCH. If the MSCH is the only logical channel mapped in to the FACH, the absence of the TCTF field is explicitly signaled otherwise, the TCTF field is used in the MAC header to identify MSCH logical channel type

MBMS is a broadcasting service and a general description of MBMS follows to provide the reader a general background for the understanding of MBMS. 3GPP TS 22.146 describes two modes of operation, the broadcast mode and the multicast mode, for Multimedia Broadcast/Multicast Service. This general description of MBMS is not intended to be exhaustive and all inclusive and does not limit the invention to any particular designs or arrangements. The general description is only presented herein for purposes of background information on the broadcast and multicast transmission modes in an MBMS system.

As known and understood by those skilled in the art, the broadcast mode of operation in MBMS transmits data over a common radio channel and is a unidirectional point-to-multipoint (P-T-M) transmission of multimedia data (e.g. text, audio, picture, video) from a single source entity to all users in a broadcast service area.

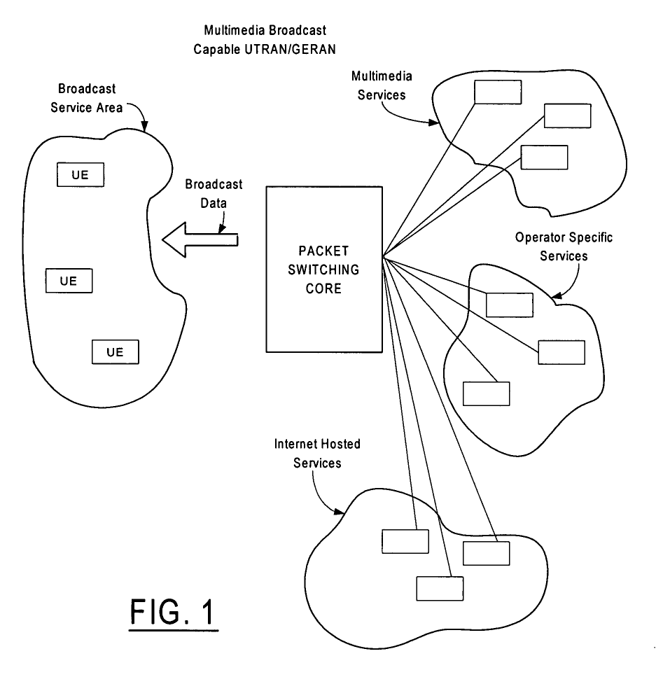

FIG. 1 is a schematic functional representation of one example of broadcast mode operation in an MBMS network configuration for broadcasting a variety of high bit rate services to users within the associated broadcast service area. A broadcast service received by the user equipment (UE), involves one or more successive broadcast sessions and might, for example, consist of a single on-going session such as a media stream or may involve several intermittent sessions over an extended period of time such as with messages. A service using the broadcast mode of operation in MBMS might be for example, advertising or a welcome message to the network. In this example, not all users connected to the network may wish to receive these messages and therefore the user has the ability to selectively enable/disable the reception of the broadcast service on his UE.

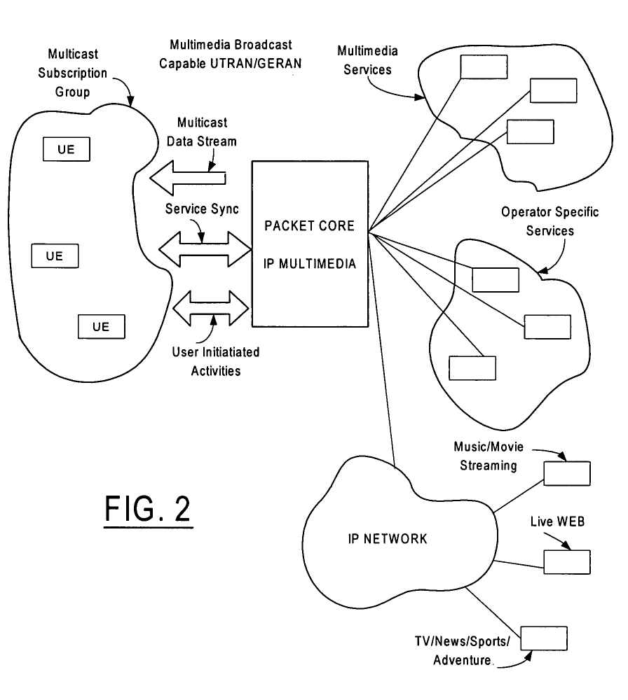

FIG. 2 is a schematic functional representation of one example of a multicast mode of operation in an MBMS network configuration for the unidirectional point-to-multipoint (P-T-M) transmission of multimedia data (e.g. text, audio, picture, video) from a single source point to a multicast group in a multicast service area. In the multicast mode of operation, the network may selectively transmit to cells within the multicast service area which contain members of a multicast group. A multicast service received by the UE, involves one or more successive multicast sessions and might, for example, consist of a single on-going session such as a multimedia stream or may involve several intermittent multicast sessions over an extended period of time such as with messages. A service using the multicast mode of operation might be for example a baseball or soccer results service for which a subscription is required.

The broadcast mode of operation differs from the multicast mode of operation in that there is no specific requirement to activate or subscribe to the MBMS in the broadcast mode of operation.

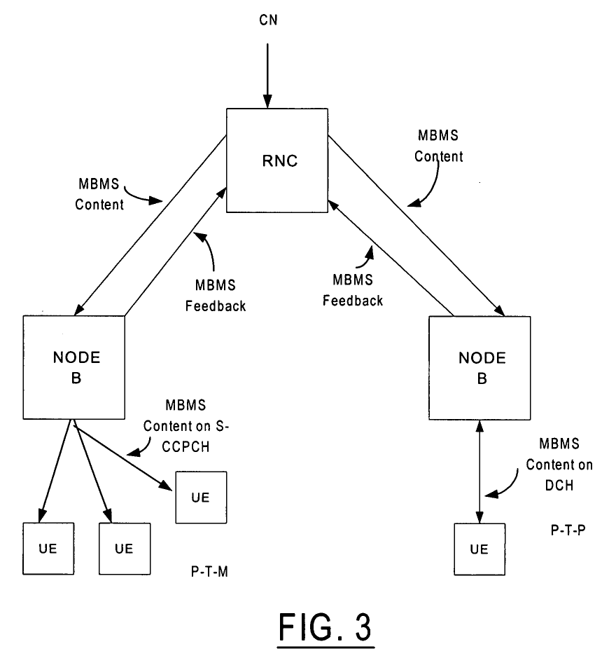

FIG. 3 is a schematic functional representation of an example of an MBMS network configuration in which one cell uses the point-to-multipoint (P-T-M) transmission mode while another cell has only one user equipment (UE) connected and which is kept in the point-to-point (P-T-P) transmission mode state. From the MBMS operational point of view, the procedures are obviously simpler if the content is always provided in a P-T-M transmission mode without shifting users back and forth between different states.

The P-T-P transmission mode is used to transfer MBMS specific control/user plane information as well as dedicated control/user plane information between the network and one UE in the radio resource control (RRC) Connected Mode and is used only for the multicast mode of operation of MBMS. For a UE in forward access transport channel (CELL_FACH) and dedicated transport channel state (Cell_DCH), a dedicated control channel (DCCH) or dedicated traffic channel (DTCH) is used, allowing all existing mappings to transport channels.

The P-T-M transmission mode is used to transfer MBMS specific control/user plane information between the network and several UEs in RRC Connected or Idle Mode and is used for both the broadcast and the multicast transmission modes of operation of MBMS.

The reader is referred to the literature in the art and numerous text references for a further details and understanding of MBMS.

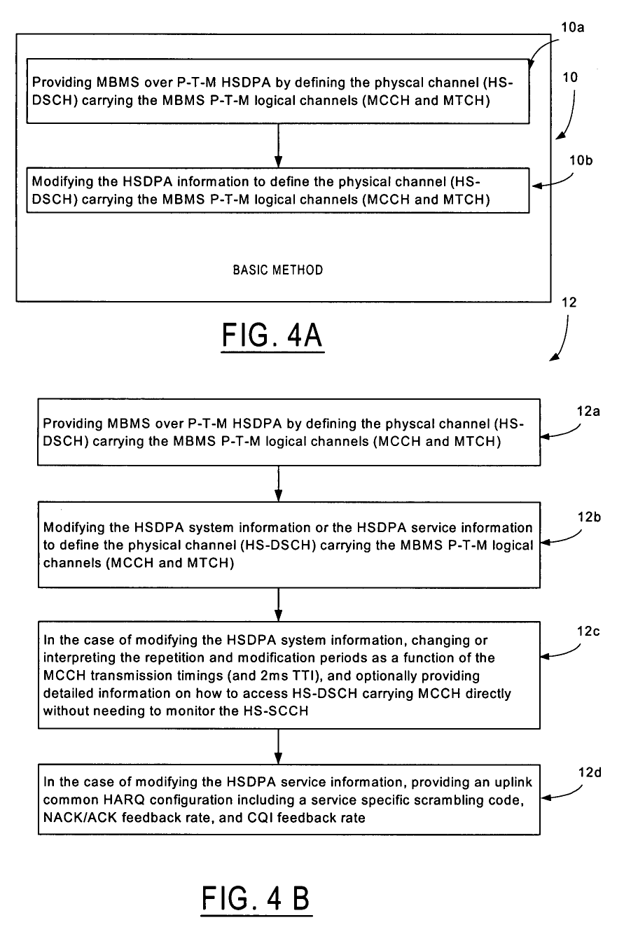

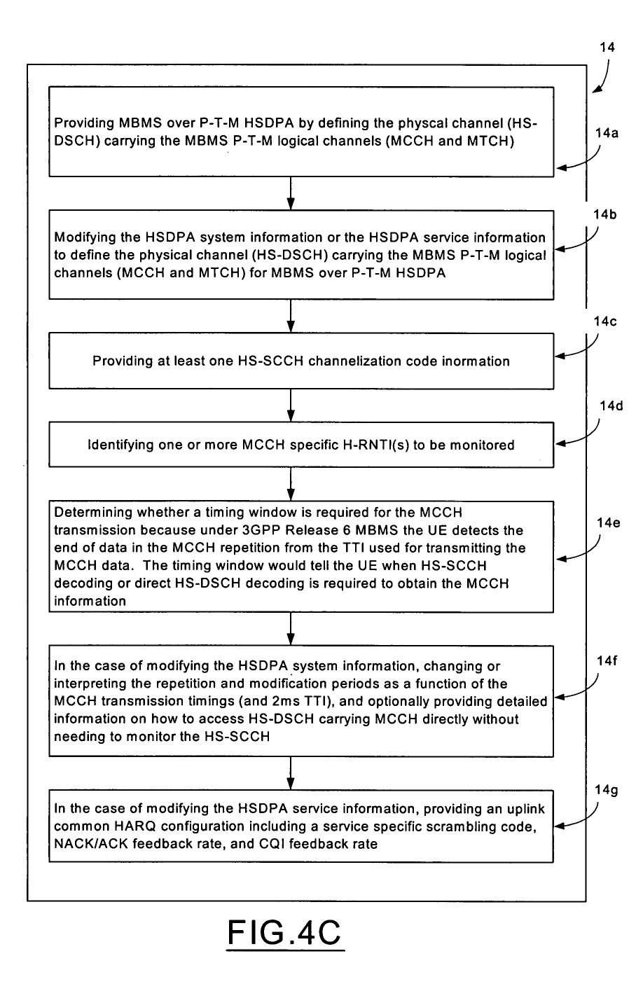

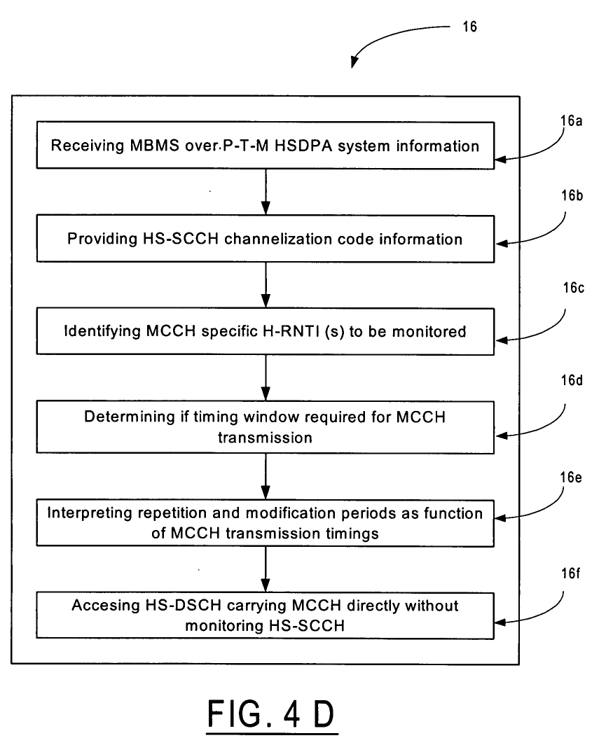

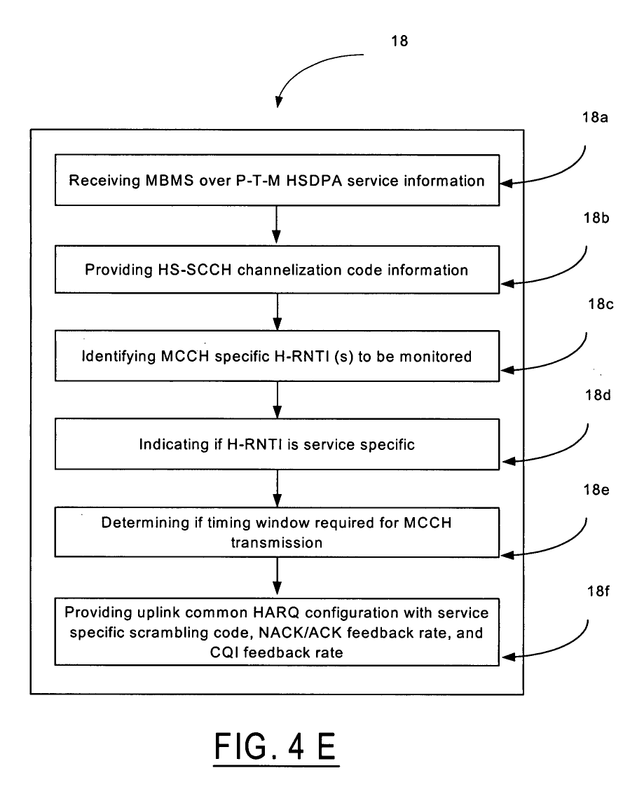

FIGS. 4A-4E show flowcharts of the basic steps of the method according to some embodiments of the invention for providing MBMS over HSDPA information. The basic method is shown in the flowchart 10 in FIG. 4A and provides for the simple introduction of HSDPA over MBMS specific signaling by re-using existing structures. The method includes the steps of providing MBMS over P-T-M HSPDA information by defining the physical channel (HS-DSCH) carrying the MBMS P-T-M logical channels (MCCH and MTCH) (step 10a) by modifying the HSDPA information to define the physical channel (HS-DSCH) carrying the MBMS P-T-M logical channels (MCCH and MTCH) (step 10b).

The method according to some embodiments of the invention for providing MBMS over HSDPA information is shown in the flowchart 12 shown in FIG. 4B. The method includes the steps of providing MBMS over P-T-M HSPDA information for example, by a suitably configured base station or node, by defining the physical channel (HS-DSCH) carrying the MBMS P-T-M logical channels (MCCH and MTCH) (step 12a) by modifying the HSDPA system information or the HSDPA service information to define the physical channel (HS-DSCH) carrying the MBMS P-T-M logical channels (MCCH and MTCH) (step 12b). In the case of modifying the HSDPA system information, changing or interpreting the repetition and modification periods as a function of the MCCH transmission timings (and 2 ms TTI), and optionally providing detailed information on how to access the HS-DSCH carrying the MCCH directly without needing to monitor the HS-SCCH (step 12c), and in the case of modifying the HSDPA service information, providing an uplink common HARQ configuration including a service specific scrambling code, NACK/ACK feedback rate, and CQI feedback rate (step 12d).

The method according to some embodiments of the invention for providing MBMS over HSDPA information is shown in the flowchart 14 shown in FIG. 4C. The method includes the steps of providing MBMS over P-T-M HSPDA information by defining the physical channel (HS-DSCH) carrying the MBMS P-T-M logical channels (MCCH and MTCH) (step 14a) by modifying the HSDPA system information or the HSDPA service information to define the physical channel (HS-DSCH) carrying the MBMS P-T-M logical channels (MCCH and MTCH) for MBMS over P-T-M HSDPA (step 14b), providing at least one HS-SCCH channelization code information (step 14c), identifying one or more MCCH specific H-RNTI(s) to be monitored (step 14d), determining whether a timing window is required for the MCCH transmission because under 3GPP Release 6 MBMS the UE detects the end of data in the MCCH repetition from the TTI used for transmitting the MCCH data, the presence of the timing window conditioning the UE when HS-SCCH decoding or direct HS-DSCH decoding is required to obtain the MCCH information (step 14e). In the case of modifying the HSDPA system information, changing or interpreting the repetition and modification periods as a function of the MCCH transmission timings (and 2 ms TTI), and optionally providing detailed information on how to access the HS-DSCH carrying the MCCH directly without needing to monitor the HS-SCCH (step 14f), and in the case of modifying the HSDPA service information, providing an uplink common HARQ configuration including a service specific scrambling code, NACK/ACK feedback rate, and CQI feedback rate (step 14g).

The basic method according to some embodiments of the invention is shown in the flowchart 16 in FIG. 4D and includes the steps for receiving, for example in a suitably configured user equipment or mobile terminal, MBMS over P-T-M HSDPA system information (step 16a), providing HS-SCCH channelization code information (step 16b), identifying MCCH specific H-RNTI(s) to be monitored (step 16c), determining if a timing window is required for MCCH transmission (step 16d), interpreting repetition and modification periods as a function of MCCH transmission timings (step 16e) and accessing the HS-DSCH carrying MCCH directly without monitoring the HS-SCCH (step 16f). In this example of the invention, the MCCH “access” information provided on BCCH is modified to support similar mobility as described and defined in 3GPP Release 6 MBMS.

The basic method according to some embodiments of the invention is shown in the flowchart 18 in FIG. 4E and includes the steps for receiving for example in a suitably configured user equipment or mobile terminal, MBMS over P-T-M HSDPA service information (step 18a), providing HS-SCCH channelization code information (step 18b), identifying MCCH specific H-RNTI(s) to be monitored (step 18c), indicating if the H-RNTI is service specific (step 18d), determining if a timing window is required for MCCH transmission (step 18e), and providing an uplink common HARQ configuration with service specific scrambling code, NACK/ACK feedback rate, and CQI feedback rate (step 18f). The service information is the information carried on the MCCH to provide access to certain transport channels (HS-DSCH) used to provide certain P-T-M service.

According to some embodiments of the invention where a fixed transmission format (fixed MCS, number of retransmission) is intended to be used on HS-DSCH, the relevant information to access the HS-DSCH directly may also be provided via the MCCH thus partially or completely removing the need for the HS-SCCH.

According to some embodiments of the invention, the UE is constantly able to receive the MCCH message and therefore the configuration changes in specific MTCH or UL feedback can be done faster compared to the Release 6 Modification period because the MCCH is mapped to HSDPA.

According to some embodiments of the invention where the same H-RNTI is used to indicate HS-DSCH transmission which can carry multiple services (and logical channels), the MSCH is still needed and the information to access it can be provided on the MCCH as described above. However, the use of service specific H-RNTI may be used, such that a single HS-DSCH would only carry user plane information related to a single MBMS Service Id and carry only one logical channel (MTCH).

According to some embodiments of the invention, using a service specific H-RNTI makes the MSCH obsolete and thereby reduces the amount of control information that needs to be transmitted.

According to some embodiments of the invention, using a service specific H-RNTI in the case of MTCH, the TCTF field is not needed in the MAC header to identify the MTCH logical channel type.

According to some embodiments of the invention, using service specific H-RNTI requires the UE to listen to multiple HS-SCCH channels if the UE desires to follow multiple services. Under current 3GPP Release 6, the UE is not required to be able to receive two independent HS-DSCH packets in one TTI, thus the Node B scheduler would need to account this.

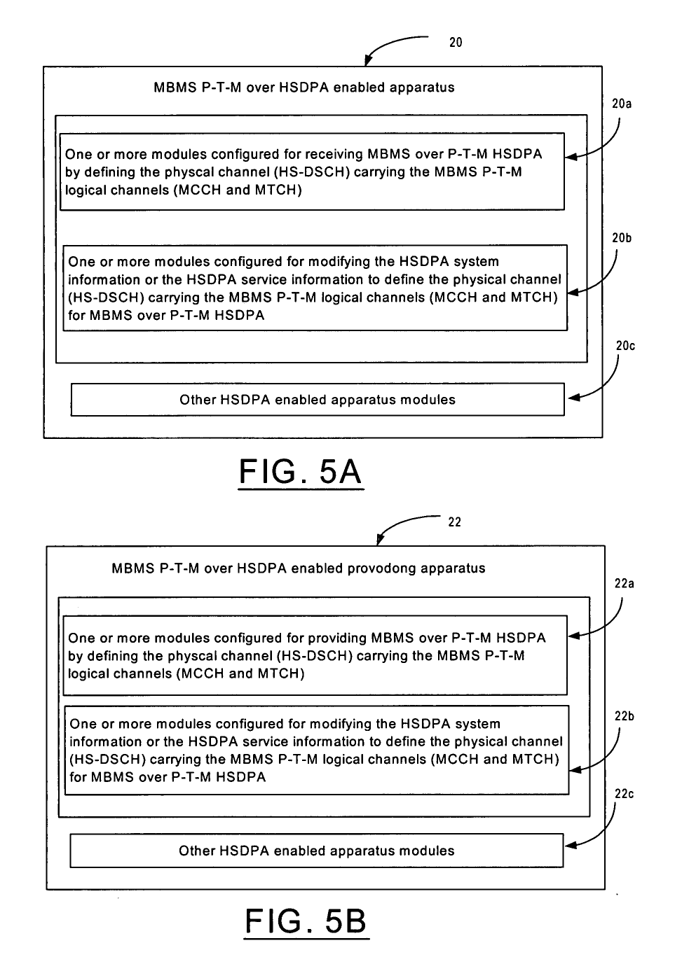

FIG. 5A shows by way of example an MBMS P-T-M over HSDPA information enabled apparatus 20 according to some embodiments of the present invention for the wireless communications system or other suitable network such as shown in FIGS. 1, 2, 3 for example. The MBMS P-T-M over HSDPA enabled apparatus in the case of a user equipment for example, includes one or more modules 20a configured for receiving MBMS over P-T-M HSDPA information by defining the physical channel (HS-DSCH) carrying the MBMS P-T-M logical channels (MCCH and MTCH), and one or more modules 20b configured for receiving the HSDPA system information or the HSDPA service information for defining the physical channel (HS-DSCH) carrying the MBMS P-T-M logical channels (MCCH and MTCH). Consistent with that described above, the MBMS P-T-M over HSDPA enabled apparatus may also have other HSDPA enabled apparatus modules 20c that do not necessarily form part of the underlying invention and are not described in detail herein.

FIG. 5B shows by way of example an MBMS P-T-M over HSDPA information enabled apparatus 22 according to some embodiments of the present invention for the wireless communications system or other suitable network such as shown in FIGS. 1, 2, 3 for example. The MBMS P-T-M over HSDPA enabled apparatus in the case of a base station or node for example, includes one or more modules 22a configured for providing MBMS over P-T-M HSDPA information by defining the physical channel (HS-DSCH) carrying the MBMS P-T-M logical channels (MCCH and MTCH), and one or more modules 22b configured for providing the HSDPA system information or the HSDPA service information for defining the physical channel (HS-DSCH) carrying the MBMS P-T-M logical channels (MCCH and MTCH). Consistent with that described above, the MBMS P-T-M over HSDPA enabled apparatus may also have other HSDPA enabled apparatus modules 22c that do not necessarily form part of the underlying invention and are not described in detail herein.

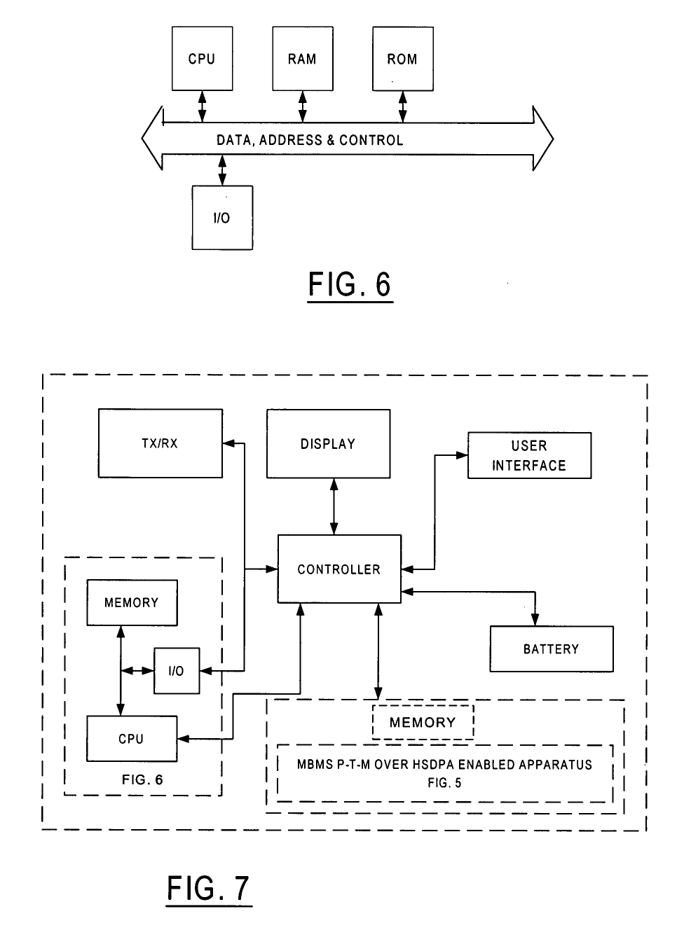

By way of example, and consistent with that described above, the functionality of the modules 20, 20a, 20b and/or 20c, 22, 22a, 22b, and/or 22c may be implemented using hardware, software, firmware, or a combination thereof, although the scope of the invention is not intended to be limited to any particular embodiment thereof. In a typical software implementation, the modules 20a and 20b would be one or more microprocessors-based architectures having a microprocessor, a random access memory (RAM), a read only memory (ROM), input/output devices and control, data and address buses connecting the same such as shown in FIG. 6. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 20a and 20b being a stand alone module, as shown, or in the combination with other circuitry for implementing another module. Moreover, the real-time part may be implemented in hardware, while the non-real-time part may be done in software.

According to some embodiments the present invention may be implemented as a computer program product comprising a computer readable structure embodying computer program code therein for execution by a computer processor instructions for performing a method comprising providing multimedia broadcast multicast service over point-to-multipoint high speed downlink packet access; defining the physical channel high speed downlink shared channel carrying the multimedia broadcast multicast service point-to-multipoint logical channels, multimedia broadcast multicast service point-to-multipoint control channel, in response to modifying the high speed downlink system or service information; providing at least one high speed shared control channel channelization code information; identifying one or more multimedia broadcast multicast service point-to-multipoint control channel specific high speed down link shared channel radio network transaction identifier(s) to be monitored; determining whether a timing window is required for the multimedia broadcast multicast service point-to-point control channel transmission for conditioning the user equipment for high speed shared control channel decoding or direct high speed downlink shared channel decoding to obtain the multimedia broadcast multicast service point-to-multipoint control channel information; in the case of modifying the high speed downlink packet access changing or interpreting the repetition and modification periods as a function of the multimedia broadcast multicast service point-to-multipoint control channel transmission timings and optionally providing detailed information on how to access the high speed downlink shared channel carrying the multimedia broadcast multicast point-to-multipoint control channel directly without needing to monitor the high speed shared control channel; in the case of modifying the high speed downlink packet access service information providing an uplink common hybrid automatic repeat request configuration including a service specific scrambling code, negative acknowledgement/acknowledgement feedback rate and channel quality indicator feed back rate when the computer program is run in a module of the terminal, node, point or device, such as a mobile terminal or user equipment.

The interactions between the major logical functions should be obvious to those skilled in the art for the level of detail needed to gain an understanding of the precepts of the present invention. It should be noted that the basic method of the invention may be implemented with an appropriate signal processor such as shown in FIG. 6, a digital signal processor or other suitable processor to carry out the intended function of the invention,

Turning now to FIG. 7, a schematic functional block diagram of a UE or mobile terminal is illustrated therein showing the major operational functional components which may be required to carry out the intended functions of the mobile terminal and implement the concept of the invention. A processor such as the signal processor of FIG. 6 carries out the computational and operational control of the mobile terminal in accordance with one or more sets of instructions stored in a memory. A user interface may be used to provide alphanumeric input and control signals by a user and is configured in accordance with the intended function to be carried out. A display sends and receives signals from the controller that controls the graphic and text representations shown on a screen of the display in accordance with the function being carried out.

The controller controls a transmit/receive unit that operates in a manner well known to those skilled in the art. The functional logical elements for carrying out the MBMS operational functions are suitably interconnected with the controller to carry out the MBMS P-T-M transmission/reception as contemplated in accordance with some embodiments of the invention. An electrical power source such as a battery is suitably interconnected within the mobile terminal to carry out the functions described above. It will be recognized by those skilled in the art that the mobile terminal may be implemented in other ways other than that shown and described.

The invention involves or is related to cooperation between elements of a communication system. Examples of a wireless communication system include implementations of GSM (Global System for Mobile Communication) and implementations of UMTS (Universal Mobile Telecommunication System). These elements of the communication systems are exemplary only and does not bind, limit or restrict the invention in any way to only these elements of the communication systems since the invention is likely to be used for B3G systems. Each such wireless communication system includes a radio access network (RAN). In UMTS, the RAN is called UTRAN (UMTS Terretrial RAN). A UTRAN includes one or more Radio Network Controllers (RNCs), each having control of one or more Node Bs, which are wireless terminals configured to communicatively couple to one or more UE terminals. The combination of an RNC and the Node Bs it controls is called a Radio Network System (RNS). A GSM RAN includes one or more base station controllers (BSCs), each controlling one or more base transceiver stations (BTSs). The combination of a BSC and the BTSs it controls is called a base station system (BSS).

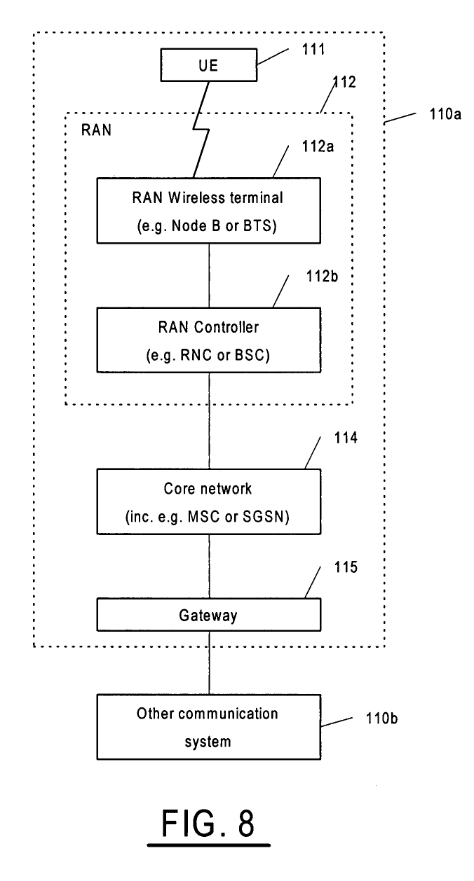

Referring now to FIG. 8, a wireless communication system 110a in which the present invention may be implemented is shown, including a UE terminal 111, a radio access network 112, a core network 114 and a gateway 115, coupled via the gateway to another communications system 110b, such as the Internet, wireline communication systems (including the so-called plain old telephone system), and/or other wireless communication systems. The radio access network includes a wireless terminal 112a (e.g. a Node B or a BTS) and a controller 112b (e.g. a RNC or a BSC). The controller is in wireline communication with the core network. The core network typically includes a mobile switching center (MSC) for circuit-switched communication, and a serving general packet radio service (GPRS) support node (SGSN) for packet-switched communication.

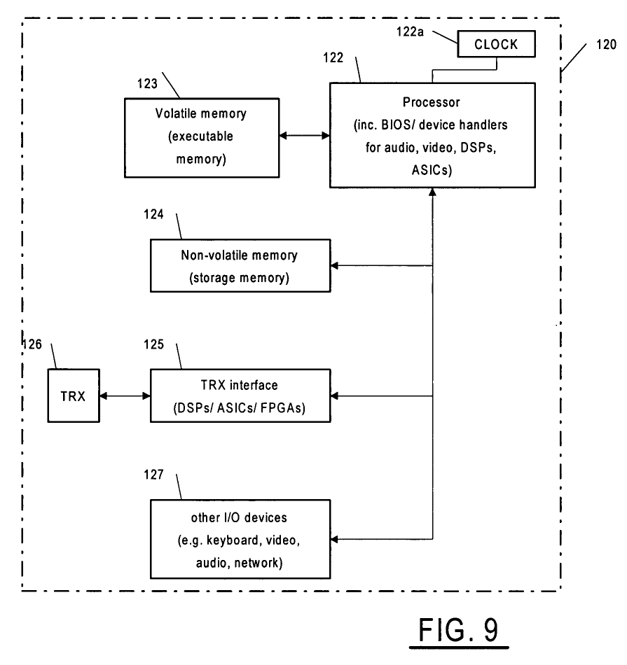

FIG. 9 shows some components of a communication terminal 120, which could be either the UE terminal 111 or the RAN wireless terminal 112a of FIG. 8. The communication terminal includes a processor 122 for controlling operation of the device, including all input and output. The processor, whose speed/timing is regulated by a clock 122a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 126 via a TRX interface 125 including possibly one or more digital signal processors (DSPs), application specific integrated circuits (ASICs), and/or field programmable gate arrays (FPGAs). The TRX enables communication over the air with another similarly equipped communication terminal.

Still referring to FIG. 9, the communication terminal includes volatile memory, i.e. so-called executable memory 123, and also non-volatile memory 124, i.e. storage memory. The processor 122 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

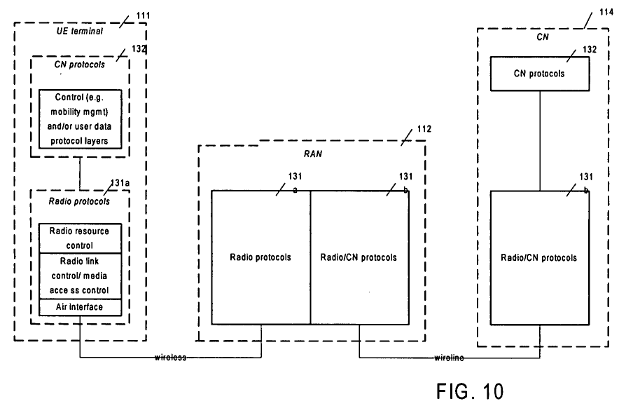

Referring now to FIG. 10, the wireless communication system of FIG. 8 is shown from the perspective of layers of a protocol according to which communication is performed. The layers of protocol form a protocol stack, and include CN protocol layers 132 located in the UE 111 and CN 114, and radio protocol layers 131a located in the UE terminal and in the RAN 112 (in either the RAN wireless terminal 112a or the RAN controller 112b). Communication is peer-to-peer. Thus, a CN protocol layer in the UE communicates with a corresponding layer in the CN, and vice versa, and the communication is provided via lower/intervening layers. The lower/intervening layers thus provide as a service to the layer immediately above them in the protocol stack the packaging or unpackaging of a unit of communication (a control signal or user data).

The CN protocols typically include one or more control protocol layers and/or user data protocol layers (e.g. an application layer, i.e. the layer of the protocol stack that interfaces directly with applications, such as a calendar application or a game application).

The radio protocols typically include a radio resource control (protocol) layer, which has as its responsibilities, among quite a few others, the establishment, reconfiguration, and release of radio bearers. Another radio protocol layer is a radio link control/media access control layer (which may exist as two separate layers). This layer in effect provides an interface with the physical layer, another of the radio access protocol layers, and the layer that enables actual communication over the air interface.

The radio protocols are located in the UE terminal and in the RAN, but not the CN. Communication with the CN protocols in the CN is made possible by another protocol stack in the RAN, indicated as the radio/CN protocols stack. Communication between a layer in the radio/CN protocols stack and the radio protocols stack in the RAN may occur directly, rather than via intervening lower layers. There is, as shown in FIG. 9, a corresponding radio/CN protocols stack located in the CN, allowing then communication between the application level in the UE terminal and the application level in the CN.

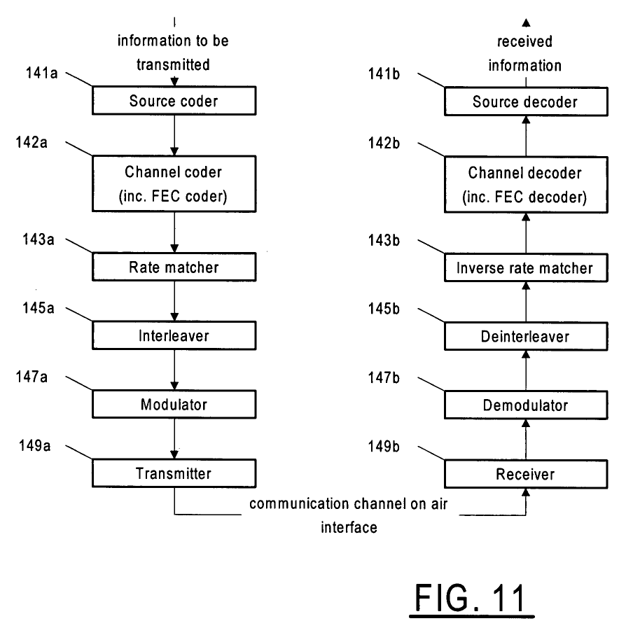

FIG. 11 is a reduced block diagram of the UE communication terminal 111 and the RAN wireless communication terminal 112a of FIG. 8, in terms of functional blocks corresponding to typically hardware (but in some cases software) equipment used in sending and receiving communication signals over a communication channel linking the two communications terminals 111, 112a. Both typically include a source coder 141a responsive to information to be transmitted, and a corresponding source decoder 141b. The source coder removes redundancy in the information not needed to communicate the information. Both also include a channel coder 142a and a corresponding channel decoder 142b. The channel coder typically adds redundancy that can be used to correct error, i.e. it performs forward error correction (FEC) coding. Both communication terminals also include a rate matcher 143a and corresponding inverse rate matcher 143b. The rate matcher adds or removes (by so-called puncturing) bits from the bit stream provided by the channel coder, in order to provide a bit stream at a rate compatible with the physical channel being used by the communication terminals. Both communication terminals also include an interleaver 145a and a deinterleaver 145b. The interleaver reorders bits (or blocks of bits) so that strings of bits representing related information are not contiguous in the output bit stream, thus making the communication more resistant to so-called bursty errors, i.e. to errors from temporary causes and so that affect the communication for only a limited time, and so affect only a portion of the communicated bit stream. Both communication terminals also include a modulator 147a and a demodulator 147b. The modulator 147a maps blocks of the bits provided by the interleaver to symbols according to a modulation scheme/mapping (per a symbol constellation). The modulation symbols thus determined are then used by a transmitter 149a included in both communication terminals, to modulate one or more carriers (depending on the air interface, e.g. WCDMA, TDMA, FDMA, OFDM, OFDMA, CDMA2000, etc.) for transmission over the air. Both communication terminals also include a receiver 149b that senses and so receives the communication terminal and determines a corresponding stream of modulation symbols, which it passes to the demodulator 147b, which in turn determines a corresponding bit stream (possibly using FEC coding to resolve errors), and so on, ultimately resulting in a providing of received information (which of course may or may not be exactly the transmitted information). Usually, the channel decoder includes as components processes that provide so-called HARQ (hybrid automatic repeat request) processing, so that in case of an error not able to be resolved on the basis of the FEC coding by the channel coder, a request is sent to the transmitter (possibly to the channel coder component) to resend the transmission having the unresolvable error.

As stated herein above, the invention may be used in any wireless system including but not limited to B3G wireless systems for example, Long Term Evolution (LTE) (also known as 3.9G), which refers to research and development involving the Third Generation Partnership Project (3GPP) aimed at identifying technologies and capabilities that can improve systems such as the UMTS.

Generally speaking, a prefix of the letter “E” in upper or lower case signifies LTE, although this rule may have exceptions. The E-UTRAN consists of eNBs (E-UTRAN Node B), providing the E-UTRA user plane (RLC/MAC/PHY) and control plane (RRC) protocol terminations towards the UE. The eNBs interface to the access gateway (aGW) via the S1, and are inter-connected via the X2.

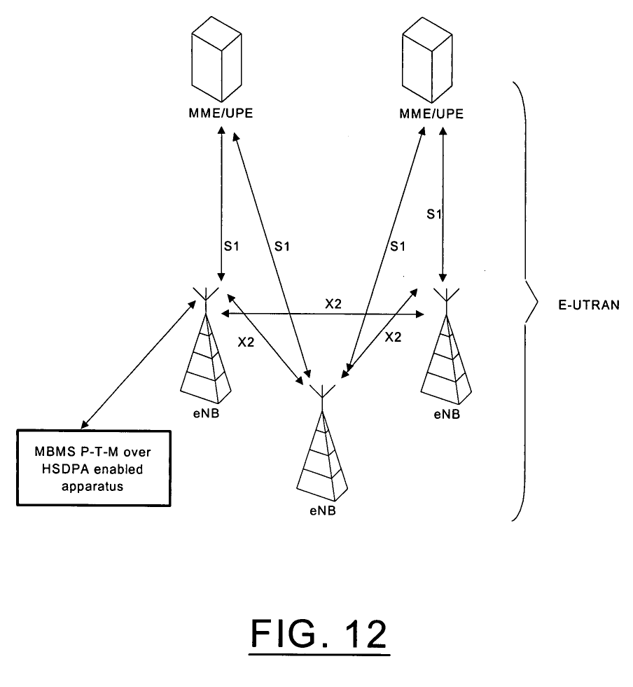

An example of the E-UTRAN architecture is illustrated in FIG. 12. This example of E-UTRAN consists of eNBs, providing the E-UTRA user plane (RLC/MAC/PHY) and control plane (RRC) protocol terminations towards the UE. The eNBs are interconnected with each other by means of the X2 interface. The eNBs are also connected by means of the S1 interface to the EPC (evolved packet core) more specifically to the MME (mobility management entity) and the UPE (user plane entity). The S1 interface supports a many-to-many relation between MMEs/UPEs and eNBs. The S1 interface supports a functional split between the MME and the UPE. The MMU/UPE in the example of FIG. 10 is one option for the access gateway (aGW).

In the example of FIG. 12, there exists an X2 interface between the eNBs that need to communicate with each other. For exceptional cases (e.g. inter-PLMN handover), LTE_ACTIVE inter-eNB mobility is supported by means of MME/UPE relocation via the S1 interface.

The eNB may host functions such as radio resource management (radio bearer control, radio admission control, connection mobility control, dynamic allocation of resources to UEs in both uplink and downlink), selection of a mobility management entity (MME) at UE attachment, routing of user plane data towards the user plane entity (UPE), scheduling and transmission of paging messages (originated from the MME), scheduling and transmission of broadcast information (originated from the MME or O&M), and measurement and measurement reporting configuration for mobility and scheduling. The MME/UPE may host functions such as the following: distribution of paging messages to the eNBs, security control, IP header compression and encryption of user data streams; termination of U-plane packets for paging reasons; switching of U-plane for support of UE mobility, idle state mobility control, SAE bearer control, and ciphering and integrity protection of NAS signaling.

The functionality described above (for both the radio access network and the UE) can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention of which:

The invention claimed:

1. Method, comprising:
providing multimedia broadcast multicast service over point-to-multipoint high speed downlink packet access, and
defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel, in response to modifying the high speed downlink packet access information.

2. The method according to claim 1 further comprising modifying the high speed downlink packet access system information.

3. The method according to claim 2 further comprising modifying the high speed downlink packet access system information by changing or interpreting the repetition and modification periods as a function of the multimedia broadcast multicast service point-to-multipoint control channel transmission timings.

4. The method according to claim 3 further comprising changing or interpreting the repetition and modification periods as a function of the transmission timing interval.

5. The method according to claim 4 wherein the transmission timing interval is 2 milliseconds.

6. The method according to claim 1 further comprising providing detailed information on how to access the high speed downlink shared channel carrying the multimedia broadcast multicast service point-to-multipoint control channel directly without monitoring the high speed shared control channel.

7. The method according to claim 1 further comprising modifying the high speed downlink packet access service information.

8. The method according to claim 7 further comprising modifying the high speed downlink packet access service information by providing an uplink common hybrid automatic repeat request configuration.

9. The method according to claim 8 further comprising the uplink common hybrid automatic repeat request configuration including a service specific scrambling code.

10. The method according to claim 8 further comprising the uplink common hybrid automatic repeat request configuration including a negative acknowledgement/acknowledgement feedback rate.

11. The method according to claim 8 further comprising the uplink common hybrid automatic repeat request configuration including a channel quality information feedback rate.

12. The method according to claim 1 further comprising providing at least one high speed shared control channel channelization code information.

13. The method according to claim 1 further comprising identifying one or more multimedia broadcast multicast service point-to-multipoint control channel specific high speed downlink shared channel radio network transaction identifiers to be monitored.

14. The method according to claim 13 further comprising indicating whether or not the high speed downlink shared channel radio network transaction identifier is service specific.

15. The method according to claim 1 further comprising determining whether a timing window is required for the multimedia broadcast multicast service point-to-multipoint control channel transmission for conditioning the user equipment for high speed shared control channel decoding or direct high speed downlink shared channel decoding to obtain the multimedia broadcast multicast service point-to-multipoint control channel information.

16. Apparatus, comprising:
one or more modules configured for providing multimedia broadcast multicast service over point-to-multipoint high speed downlink packet access, and
one or more modules configured for providing the high speed downlink packet access information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.

17. The apparatus according to claim 16 further comprising one or more modules configured for modifying the high speed downlink packet access system information by changing or interpreting the repetition and modification periods as a function of the multimedia broadcast multicast service point-to-multipoint control channel transmission timings.

18. The apparatus according to claim 17 further comprising one or more modules configured for providing detailed information on how to access the high speed downlink shared channel carrying the multimedia broadcast multicast service point-to-multipoint control channel directly without monitoring the high speed shared control channel.

19. The apparatus according to claim 16 further comprising one or more modules configured for determining whether a timing window is required for the multimedia broadcast multicast service point-to-multipoint control channel transmission for conditioning the user equipment for high speed shared control channel decoding or direct high speed downlink shared channel decoding to obtain the multimedia broadcast multicast service point-to-multipoint control channel information.

20. The apparatus according to claim 16 further comprising one or modules configured for modifying the high speed downlink packet access service information by providing an uplink common hybrid automatic repeat request configuration.

21. The apparatus according to claim 20 further comprising one or more modules configured for including a service specific scrambling code, a negative acknowledgement/acknowledgement feedback rate and a channel quality information feedback rate in the uplink common hybrid automatic repeat request configuration.

22. The apparatus according to claim 16 further comprising one or more modules configured for providing at least one high speed shared control channel channelization code information.

23. The apparatus according to claim 16 further comprising a base station, node or device.

24. Method, comprising:
receiving in a suitably configured user equipment multimedia broadcast multicast service over point-to-multipoint high speed downlink packet access, and
receiving in the user equipment the high speed downlink packet access information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.

25. Apparatus, comprising:
one or more modules configured for receiving multimedia broadcast multicast service over point-to-multipoint high speed downlink packet access, and
one or more modules configured for receiving the high speed downlink packet access information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.

26. The apparatus according to claim 25 further comprising one or more modules configured for receiving the high speed downlink packet access system information by changing or interpreting the repetition and modification periods as a function of the multimedia broadcast multicast service point-to-multipoint control channel transmission timings.

27. The apparatus according to claim 26 further comprising one or more modules configured for receiving detailed information on how to access the high speed downlink shared channel carrying the multimedia broadcast multicast service point-to-multipoint control channel directly without monitoring the high speed shared control channel.

28. The apparatus according to claim 25 further comprising one or more modules configured for determining whether a timing window is required for the multimedia broadcast multicast service point-to-multipoint control channel transmission for conditioning the user equipment for high speed shared control channel decoding or direct high speed downlink shared channel decoding to obtain the multimedia broadcast multicast service point-to-multipoint control channel information.

29. The apparatus according to claim 25 further comprising one or modules configured for modifying the high speed downlink packet access service information by providing an uplink common hybrid automatic repeat request configuration.

30. The apparatus according to claim 29 further comprising one or more modules configured for including a service specific scrambling code, a negative acknowledgement/acknowledgement feedback rate and a channel quality information feedback rate in the uplink common hybrid automatic repeat request configuration.

31. The apparatus according to claim 25 further comprising one or more modules configured for providing at least one high speed shared control channel channelization code information.

32. Apparatus, comprising:
means for providing multimedia broadcast multicast service over point-to-multipoint high speed downlink packet access, and
means for modifying the high speed downlink packet access system information or the high speed downlink packet access service information for defining the physical channel high speed downlink shared channel carrying the multimedia broadcast multicast service point-to-multipoint logical channels multimedia broadcast multicast service point-to-multipoint control channel and multimedia broadcast multicast service point-to-multipoint traffic channel.

33. A computer program product comprising a computer readable structure embodying computer program code therein for execution by a computer processor, said computer program further comprising instructions for performing a method comprising providing multimedia broadcast multicast service over point-to-multipoint high speed downlink packet access; defining the physical channel high speed downlink shared channel carrying the multimedia broadcast multicast service point-to-multipoint logical channels, multimedia broadcast multicast service point-to-multipoint control channel, in response to modifying the high speed downlink system or service information; providing at least one high speed shared control channel channelization code information; identifying one or more multimedia broadcast multicast service point-to-multipoint control channel specific high speed down link shared channel radio network transaction identifier(s) to be monitored; determining whether a timing window is required for the multimedia broadcast multicast service point-to-point control channel transmission for conditioning the user equipment for high speed shared control channel decoding or direct high speed downlink shared channel decoding to obtain the multimedia broadcast multicast service point-to-multipoint control channel information; in the case of modifying the high speed downlink packet access changing or interpreting the repetition and modification periods as a function of the multimedia broadcast multicast service point-to-multipoint control channel transmission timings and optionally providing detailed information on how to access the high speed downlink shared channel carrying the multimedia broadcast multicast point-to-multipoint control channel directly without needing to monitor the high speed shared control channel; in the case of modifying the high speed downlink packet access service information providing an uplink common hybrid automatic repeat request configuration including a service specific scrambling code, negative acknowledgement/acknowledgement feedback rate and channel quality indicator feed back rate when the computer program is run in a module of the terminal, node, point or device, such as a mobile terminal or user equipment.

34. A method according to claim 1, wherein the method further comprises implementing the step of the method via a computer program running in a processor, controller or other suitable module in one or more terminals, nodes, access points or devices in a cellular network.

35. System, comprising:
a suitably configured and arranged wireless communication;
a base station, comprising:
one or more modules and configured for providing multimedia broadcast multicast service over point-to-multipoint high speed downlink packet access, and
one or more modules configured for providing the high speed downlink packet access information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel;
a user equipment, comprising:
one or more modules configured for receiving multimedia broadcast multicast service over point-to-multipoint high speed downlink packet access, and
one or more modules configured for receiving the high speed downlink packet access information for defining the physical channel high speed downlink shared channel carrying the multimedia broadcast multicast service point-to-multipoint logical channels, multimedia broadcast multicast service point-to-multipoint control channel and multimedia broadcast multicast service point-to-multipoint traffic channel.
